(19) United States
(12) Patent Application Publication
(10) Pub. No.: US 2012/0185658 A1
(43) Pub. Date: Jul. 19, 2012

(54) PERFORMING WRITING OPERATIONS USING A QUEUE OF AVAILABLE PAGES

(75) Inventors: William A. Brown, Pine Island, MN (US); Thomas R. Crowley, Rochester, MN (US); Steven M. Howe, Rochester, MN (US)

(73) Assignee: INTERNATIONAL BUSINESS MACHINES CORPORATION, Armonk, NY (US)

(21) Appl. No.: 13/008,061

(22) Filed: Jan. 18, 2011

(51) Int. Cl. G06F 12/16

(52) U.S. Cl. 711/162; 711/E12.103

(57) ABSTRACT

A method for performing a write operation on a computer system having a main store, including a plurality of pages, and a backing store, the write operation including a processing step for processing data of the write operation and a writing step for writing the processed data to the backing store. The method includes reserving a set of pages, among the plurality of pages, in the main store, retrieving a required number of pages from the reserved set in accordance with the size of the data, processing the required number of pages of the data using the retrieved pages, writing the processed data to the backing store, and returning the retrieved pages to the reserved set upon finishing the writing.

### BACKGROUND

1. Technical Field

The present invention relates to computer system management or storage system management. More specifically, it relates to a method and apparatus for maintaining a queue of available pages of a main store of a computer system, so as to provide a steady stream of input/output (I/O) operations to a backing store of the computer system.

2. Background Information

A computer system usually has a main store and a backing store. The main store, also known as the main storage, main memory or primary store, is a storage device closely associated with the processor of the computer system, and from which program instructions and data can be retrieved rapidly and copied directly into the processor registers, and in which the resulting data is stored prior to being transferred to the backing store. An example of the main store is the RAM (Random Access Memory). The main store usually stores data waiting processing, being processed, or resulted from processing. The backing store of a computer system, on the other hand, has a much larger storage capacity, is less expensive, and usually provides slower access than the main store, for storing instructions or data received from the main store. A disk subsystem of the computer system is an example of the backing store.

The main store of a computer system is composed of a number of pages, which is the unit of interchange between the main store and the backing store. A page includes a fixed number of words or bytes for a given computer system, and is used to keep, for exchanging between the main store and the backing store, program instructions, data or both. FIG. 1 shows a main store 100 of a computer system including a plurality of pages 110. Each page 110 is used to exchange instructions or data with the backing store, the disk sub-system 120.

For many applications, a write operation of a computer system requires two steps: a processing step for processing the data associated with a write request, and a writing step to write the processed data to the backing store. For example, for data security purposes, many users of a computer system require that the data on the backing store (e.g. the disk media) to be encrypted. As such, the user data have to be processed (i.e. encrypted) in the main store and then sent to the backing store. However, a piece of data cannot be encrypted “in place” in the main store, because doing so would prevent other applications of the computer system from using the piece of data both during the processing step (i.e. the entire encryption process in the main store), and during the writing step (i.e. the process of write the encrypted data to the backing store). Therefore, the piece of data, of one page in the main store, is usually encrypted into another page in the main store, which can be subsequently sent, via DMA (Direct Memory Access), to the backing store such as the disk subsystem, as illustrated in FIG. 1.

### SUMMARY

A method for performing a write operation on a computer system having a main store, including a plurality of pages, and a backing store, the write operation including a processing step for processing data of the write operation and a writing step for writing the processed data to the backing store. The method includes reserving a set of pages, among the plurality of pages, in the main store, retrieving a required number of pages from the reserved set in accordance with the size of the data, processing the required number of pages of the data using the retrieved pages, writing the processed data to the backing store, and returning the retrieved pages to the reserved set upon finishing the writing.

### BRIEF DESCRIPTION OF DRAWINGS

FIG. 1 is a block diagram showing a main store including a plurality of pages and a backing store (i.e. a disk subsystem).

FIG. 2 is a block diagram showing the queue of available pages.

FIG. 3 illustrates the pool of I/O requests and the main store pages associated with the I/O requests.

FIG. 4 is a flow chart showing the process of streaming a write operation using the QOAP in one embodiment of the present invention.

FIG. 5 illustrates a computer system upon which the present invention may be implemented.

### DETAILED DESCRIPTION

The invention will now be described in more detail by way of example with reference to the embodiments shown in the accompanying Figures. It should be kept in mind that the following described embodiments are only presented by way of example and should not be construed as limiting the inventive concept to any particular physical configuration. Further, if used and unless otherwise stated, the terms “upper,” “lower,” “front,” “back,” “over,” “under,” and similar such terms are not to be construed as limiting the invention to a particular orientation. Instead, these terms are used only on a relative basis.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable media may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In one embodiment of the present invention, rather than serializing the I/O operations waiting for main store pages so that data can be encrypted into the main store pages, a queue of available pages (QOAP) may be used to maintain the I/O operations (specifically, write operations) flowing to the disk subsystem, so as to improve the writing and encryption performance and to avoid deadlocks.

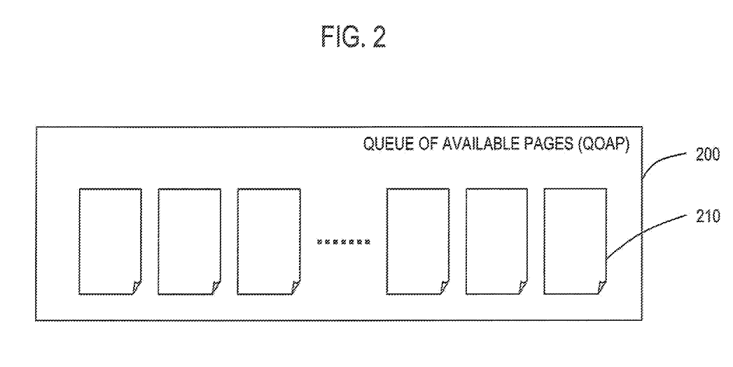

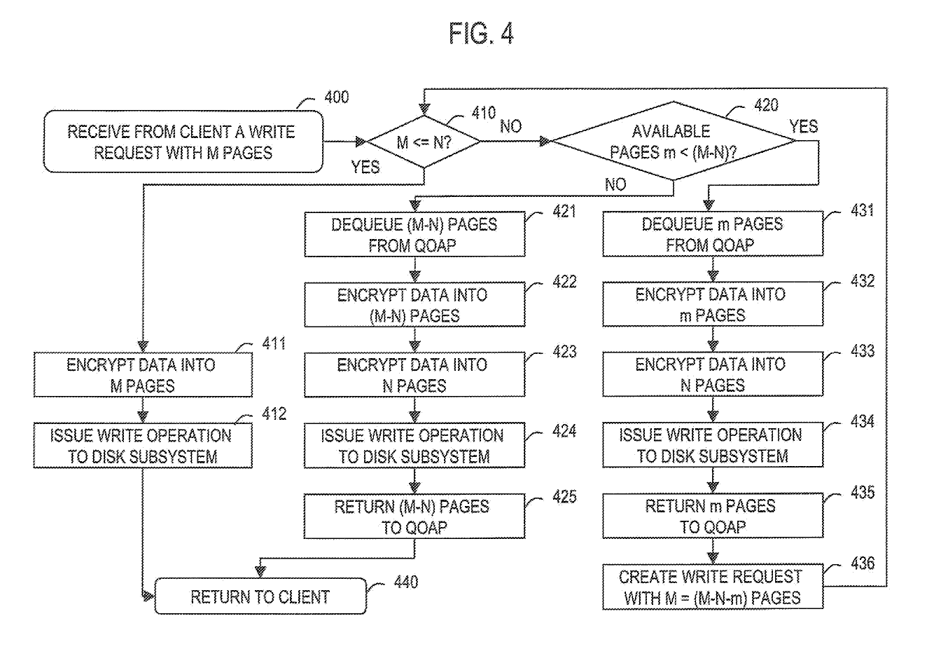

In one embodiment of the invention as illustrated in FIG. 2, a QOAP 200 may contain a number of pages 210 reserved specifically for storing encrypted data. For example, as described in detail below with respect to FIG. 4, the QOAP 200 may be utilized to provide main store pages 210 for a write operation to generate encrypted data. Upon the completion of the write operation, the provided main store pages would be returned to the QOAP 200. If the QOAP 200 does not contain enough main store pages for performing a full I/O operation, the I/O operation will be broken up into multiple requests, each of which can use the maximum number of main store pages that can be successfully allocated from the QOAP 200.

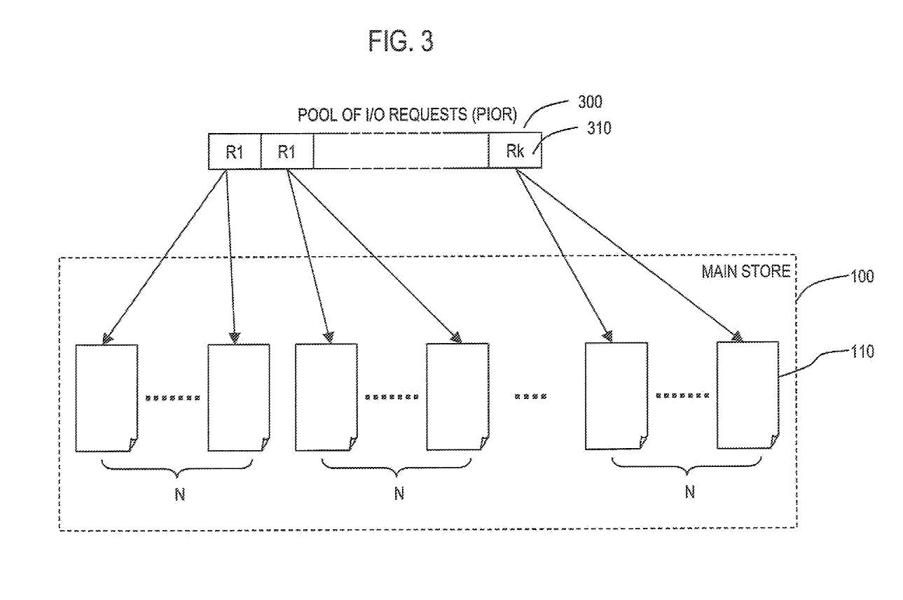

In one embodiment of the invention, as illustrated in FIG. 3, all I/O operations requested by the users may be maintained in a Pool of I/O Requests (PIOR) 300. Each I/O Request 310 in PIOR 300 has a number N of main store pages associated with it—these N pages can be used to store encrypted data for the I/O operation. It is usually not feasible to make each I/O Request 310 have the maximum number of main store pages allowed by the architecture of the computer. In one embodiment of the invention, each I/O Request 310 is associated with 7 main store pages (i.e., N=7).

FIG. 4 is a flow chart showing the process of streaming a write operation using the QOAP in one embodiment of the present invention. After a write operation request from a user, with a length of M pages, is received (step 400), the number M is compared to N, the number of main store pages associated with each I/O request (step 410). M is a value between 1 and the maximum number of pages to I/O operations allowed by the architecture, e.g. 32. If M is less than or equal to N, the requested write operation can be performed without using the main store pages in the QOAP 200. Thus, the user data is encrypted into the pages associated with the I/O request (step 411), and the write operation is issued to the disk subsystem (step 412).

However, if M is larger than N, the main store pages reserved for each I/O request is not sufficient for finishing the requested operation. If so, a main store page shortage, i.e. the difference between M and N, is calculated and compared to the number m of the maximum available main store pages in the QOAP 200 (step 420).

If m is larger than or equal to the main storage page shortage (M−N), the QOAP 200 can provide enough main store pages for finishing the writing request. Therefore, a number (M−N) of main store pages are de-queued from the QOAP 200 (step 421), the corresponding user data is encrypted into the (M−N) pages (step 422) as well as the N pages associated with each I/O request (step 423), and then the write operation is issued to the disk subsystem (step 424). At the completion of the write operation, the (M—N) main store pages are returned to the QOAP 200 (step 425).

However, if m is smaller than the main storage page shortage (M−N), and accordingly the QOAP 200 cannot provide enough main store pages for finishing the writing request, the m main store pages in the QOAP 200 are de-queued (step 431), (m+N) pages of the user data are encrypted into the m main store pages (step 432) as well as the N pages associated with the write operation (step 433), and then the write operation is issued to the disk subsystem (step 434). Upon the completion of the write operation, the m main store pages are returned to the QOAP 200 (step 435), and another write request with M=(M−N−m) pages is created (step 436), and the process restarts from step 410.

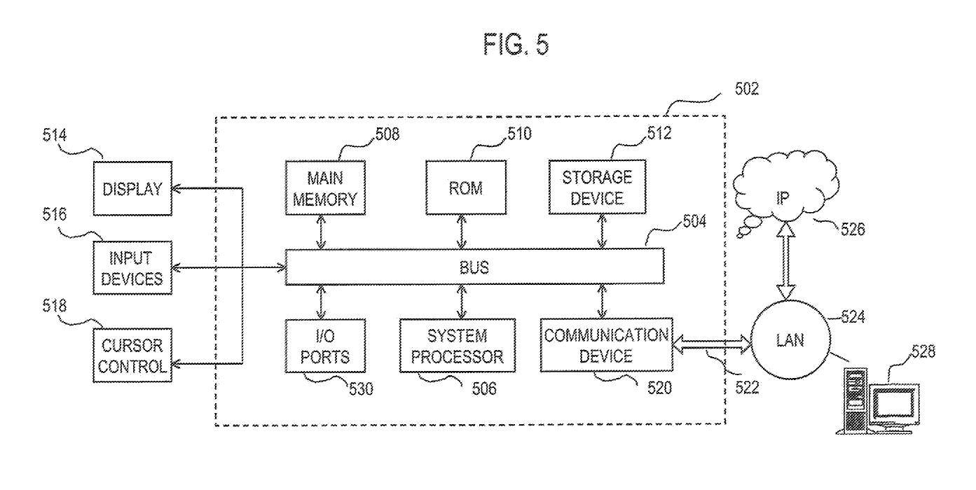

FIG. 5 illustrates a computer system (502) upon which the present invention may be implemented. The computer system may be any one of a personal computer system, a work station computer system, a laptop computer system, an embedded controller system, a microprocessor-based system, a digital signal processor-based system, a hand held device system, a personal digital assistant (PDA) system, a wireless system, a wireless networking system, etc. The computer system includes a bus (504) or other communication mechanism for communicating information and a processor (506) coupled with bus (504) for processing the information. The computer system also includes a main memory (508), such as a random access memory (RAM) or other dynamic storage device (e.g., dynamic RAM (DRAM), static RAM (SRAM), synchronous DRAM (SDRAM), flash RAM), coupled to bus for storing information and instructions to be executed by processor (506). In addition, main memory (508) may be used for storing temporary variables or other intermediate information during execution of instructions to be executed by processor. The computer system further includes a read only memory (ROM) 510 or other static storage device (e.g., programmable ROM (PROM), erasable PROM (EPROM), and electrically erasable PROM (EEPROM)) coupled to bus 504 for storing static information and instructions for processor. A storage device (512), such as a magnetic disk or optical disk, is provided and coupled to bus for storing information and instructions. This storage device is an example of a computer readable medium.

The computer system also includes input/output ports (530) to input signals to couple the computer system. Such coupling may include direct electrical connections, wireless connections, networked connections, etc., for implementing automatic control functions, remote control functions, etc. Suitable interface cards may be installed to provide the necessary functions and signal levels.

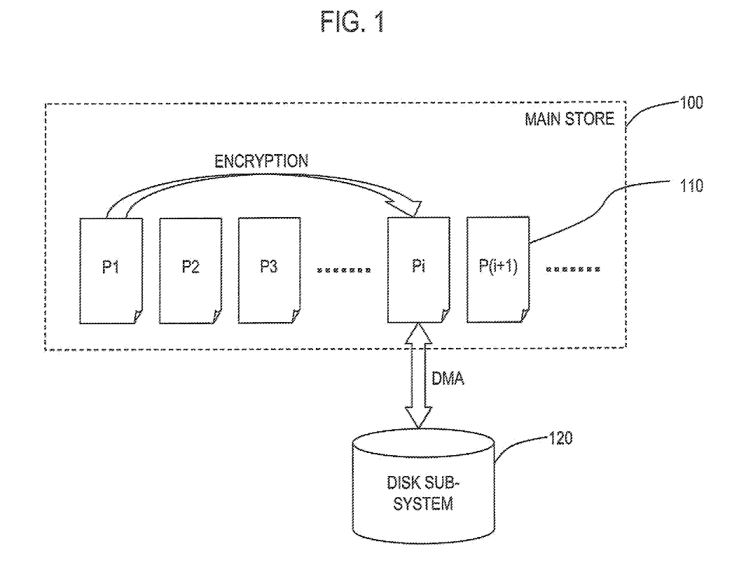

The computer system may also include special purpose logic devices (e.g., application specific integrated circuits (ASICs)) or configurable logic devices (e.g., generic array of logic (GAL) or re-programmable field programmable gate arrays (FPGAs)), which may be employed to replace the functions of any part or all of the method as described with reference to FIGS. 1-4. Other removable media devices (e.g., a compact disc, a tape, and a removable magneto-optical media) or fixed, high-density media drives, may be added to the computer system using an appropriate device bus (e.g., a small computer system interface (SCSI) bus, an enhanced integrated device electronics (IDE) bus, or an ultra-direct memory access (DMA) bus). The computer system may additionally include a compact disc reader, a compact disc reader-writer unit, or a compact disc jukebox, each of which may be connected to the same device bus or another device bus.

The computer system may be coupled via bus (504) to a display (514), such as a cathode ray tube (CRT), liquid crystal display (LCD), voice synthesis hardware and/or software, etc., for displaying and/or providing information to a computer user. The display may be controlled by a display or graphics card. The computer system includes input devices (516), such as a keyboard and a cursor control (518), for communicating information and command selections to processor (506). Such command selections can be implemented via voice recognition hardware and/or software functioning as the input devices (516). The cursor control (518), for example, is a mouse, a trackball, cursor direction keys, touch screen display, optical character recognition hardware and/or software, etc., for communicating direction information and command selections to processor (506) and for controlling cursor movement on the display (514). In addition, a printer (not shown) may provide printed listings of the data structures, information, etc., or any other data stored and/or generated by the computer system.

The computer system performs a portion or all of the processing steps of the invention in response to processor executing one or more sequences of one or more instructions contained in a memory, such as the main memory. Such instructions may be read into the main memory from another computer readable medium, such as storage device. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

The computer code devices of the present invention may be any interpreted or executable code mechanism, including but not limited to scripts, interpreters, dynamic link libraries, Java classes, and complete executable programs. Moreover, parts of the processing of the present invention may be distributed for better performance, reliability, and/or cost.

The computer system also includes a communication interface (520) coupled to bus. The communication interface (520) provides a two-way data communication coupling to a network link (522) that may be connected to, for example, a local network (524). For example, the communication interface (520) may be a network interface card to attach to any packet switched local area network (LAN). As another example, the communication interface (520) may be an asymmetrical digital subscriber line (ADSL) card, an integrated services digital network (ISDN) card or a modem to provide a data communication connection to a corresponding type of telephone line. Wireless links may also be implemented via the communication interface (520). In any such implementation, the communication interface (520) sends and receives electrical, electromagnetic or optical signals that carry digital data streams representing various types of information.

Network link (522) typically provides data communication through one or more networks to other data devices. For example, the network link may provide a connection to a computer (528) through local network (524) (e.g., a LAN) or through equipment operated by a service provider, which provides communication services through a communications network (526). In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit notifications and receive data, including program code, through the network(s), the network link and the communication interface.

It should be understood, that the invention is not necessarily limited to the specific process, arrangement, materials and components shown and described above, but may be susceptible to numerous variations within the scope of the invention.

What is claimed is:

1. A method for performing a write operation on a computer system, the computer system having a main store, including a plurality of pages, and a backing store, the write operation including a processing step for processing data of the write operation and a writing step for writing the processed data to the backing store, the data of the write operation being of a size of M pages, the method comprising:
reserving a set of pages, among the plurality of pages, in the main store;
retrieving a required number of pages from the reserved set in accordance with the size of the data, and processing the required number of pages of the data using the retrieved pages;
writing the processed data to the backing store; and
returning the retrieved pages to the reserved set upon finishing the writing.

2. The method of claim 1, wherein the required number of pages is M.

3. The method of claim 1, wherein said retrieving includes:
determining a total number of available pages in the reserved set;
if the required number is smaller than or equal to the total number, obtaining the required number of pages from the reserved set; and
if the required number is larger than the total number, obtaining all available pages from the reserved set.

4. The method of claim 3, further comprising, if the required number is larger than the total number, upon finishing the returning:
calculating a difference between the required number and the total number, and updating the required number using the difference;
determining the updated required number of pages of data that have not been processed; and
repeating said retrieving, writing and returning, using the updated required number and the unprocessed data.

5. The method of claim 1, further comprising, before retrieving the required number of pages from the reserved set:
assigning a number N of dedicated pages, from the plurality of pages but from outside the reserved set, to the write operation;
if M is smaller than or equal to N, processing the M pages of the data using the dedicated pages, and setting the required number to 0; and
if M is larger than N, processing N of the M pages of the data using the dedicated pages, and setting the required number to (M−N).

6. The method of claim 1, wherein
the set of pages is reserved using a queue, and
said retrieving includes de-queuing the required number of pages from the queue

7. A computer program product for performing a write operation on a computer system, the computer system having a main store, including a plurality of pages, and a backing store, the write operation including a processing step for processing data of the write operation and a writing step for writing the processed data to the backing store, the data of the write operation being of a size of M pages, the computer program product comprising:
a non-transitory computer usable medium having computer usable program code embodied therewith, the computer usable program code comprising:
instructions to reserve a set of pages, among the plurality of pages, in the main store;
instructions to retrieve a required number of pages from the reserved set in accordance with the size of the data, and processing the required number of pages of the data using the retrieved pages;
instructions to write the processed data to the backing store; and
instructions to return the retrieved pages to the reserved set upon finishing the writing.

8. The computer program product of claim 7, wherein the required number of pages is M.

9. The computer program product of claim 7, wherein said instructions to retrieve include:
instructions to determine a total number of available pages in the reserved set;
instructions to obtain the required number of pages from the reserved set, if the required number is smaller than or equal to the total number; and
instructions to obtain all available pages from the reserved set, if the required number is larger than the total number.

10. The computer program product of claim 9, further comprising instructions, upon finishing the returning, to calculate a difference between the required number and the total number, to update the required number using the difference, to determine the updated required number of pages of data that have not been processed, and to repeat the retrieving, writing and returning, using the updated required number and the unprocessed data, if the required number is larger than the total number.

11. The computer program product of claim 7, further comprising instructions to, before retrieving the required number of pages from the reserved set, assign a number N of dedicated pages, from the plurality of pages but from outside the reserved set, to the write operation, instructions to process the M pages of the data using the dedicated pages and to set the required number to 0, if M is smaller than or equal to N, and instructions to process N of the M pages of the data using the dedicated pages, and to set the required number to (M−N), if M is larger than N.

12. The computer program product of claim 7, wherein
the set of pages is reserved using a queue, and
said instructions to retrieve include instructions to de-queue the required number of pages from the queue.

13. A computer system comprising:
a processor;
a main store operatively coupled with the processor;
a backing store operatively coupled with the processor and the main store; and
a computer program product configured to perform a write operation on the computer system, the write operation including a processing step for processing data of the write operation and a writing step for writing the processed data to the backing store, the data of the write operation being of a size of M pages, the computer program product including:
a non-transitory computer usable medium having computer usable program code embodied therewith, the computer usable program code comprising:
instructions to reserve a set of pages, among the plurality of pages, in the main store;
instructions to retrieve a required number of pages from the reserved set in accordance with the size of the data, and processing the required number of pages of the data using the retrieved pages;
instructions to write the processed data to the backing store; and
instructions to return the retrieved pages to the reserved set upon finishing the writing.

14. The computer system of claim 13, wherein the required number of pages is M.

15. The computer system of claim 13, wherein said instructions to retrieve include:
instructions to determine a total number of available pages in the reserved set;
instructions to obtain the required number of pages from the reserved set, if the required number is smaller than or equal to the total number; and
instructions to obtain all available pages from the reserved set, if the required number is larger than the total number.

16. The computer system of claim 15, further comprising instructions, upon finishing the returning, to calculate a difference between the required number and the total number, to update the required number using the difference, to determine the updated required number of pages of data that have not been processed, and to repeat the retrieving, writing and returning, using the updated required number and the unprocessed data, if the required number is larger than the total number.

17. The computer system of claim 13, further comprising instructions to, before retrieving the required number of pages from the reserved set, assign a number N of dedicated pages, from the plurality of pages but from outside the reserved set, to the write operation, instructions to process the M pages of the data using the dedicated pages and to set the required number to 0 if M is smaller than or equal to N, and instructions to process N of the M pages of the data using the dedicated pages, and to set the required number to (M−N), if M is larger than N.

18. The computer system of claim 13, wherein
the set of pages is reserved using a queue, and
said instructions to retrieve include instructions to de-queue the required number of pages from the queue.
